(19) United States
(12) Patent Application Publication
(10) Pub. No.: US 2015/0350138 A1
(43) Pub. Date: Dec. 3, 2015

(54) CONTROLLER, MESSAGE DELIVERY SYSTEM, MESSAGE DELIVERY METHOD, AND PROGRAM

(71) Applicant: NEC CORPORATION, Tokyo (JP)

(72) Inventor: Yoshiaki SAKAE, Tokyo (JP)

(73) Assignee: NEC CORPORATION, Tokyo (JP)

(21) Appl. No.: 14/654,058

(22) PCT Filed: Dec. 19, 2013
(86) PCT No.: PCT/JP2013/084091

§ 371 Date: Jun. 19, 2015

(30) Foreign Application Priority Data
Dec. 20, 2012 (JP) 2012-278029

(51) Int. Cl. H04L 12/58

(52) U.S. Cl. CPC H04L 51/14

(57) ABSTRACT

A controller, for controlling a switch that forwards a message, comprises: a holding unit that, upon receipt of a notification including a tag from a second node that subscribes to a message delivered with the tag from a first node, associates and holds the tag and a virtual address, and associates and holds the virtual address and a physical address of the second node that transmits the notification; a setting unit that sets in the switch the association between the virtual address and the physical address; and a tag resolution unit that, upon receipt of an inquiry about the virtual address associated with the tag from the first node, responds the virtual address.

### FIELD

### CROSS-REFERENCE TO RELATED APPLICATIONS

The present application is a National Stage of International Application No. PCT/JP2013/084091, filed on Dec. 19, 2013, which claims the benefit of the priority of Japanese Patent Application No. 2012-278029 (filed on Dec. 20, 2012), the disclosure of which is incorporated herein in its entirety by reference.

The present invention relates to a controller, a message delivery system, a message delivery method, and a program. More specifically, the invention relates to a controller configured to control message delivery in message-oriented middleware, a message delivery system including such a controller, a message delivery method, and a program.

### BACKGROUND

An example of a message delivery method in message-oriented middleware (MOM) is standardized as an AMQP (Advanced Message Queuing Protocol) (in Non Patent Literature (NPL) 1).

FIG. 7 is a diagram showing an overall configuration of an AMQ (Advanced Message Queuing) model. Referring to FIG. 7, the AMQ model is configured by including a publisher application 110, a server 130, and a consumer application 140. Hereinafter, the publisher application and the consumer application will be respectively referred to as a “publisher,” and a “consumer.”

The publisher 110 generates and transmits a message.

The server 130 standardized in accordance with the AMQP includes an exchange 134 configured to deliver the message to the consumer 140 according to a predetermined criterion upon receipt of the message and a message queue 136 configured to serve as a buffer when the consumer 140 cannot receive the message (see FIG. 7). Further, there is also a server in which a concept of a virtual host 132 is implemented in order to virtually provide a plurality of combinations of the exchanges 134 and the message queues 136. Hereinafter, each message queue will be simply referred to as a “queue.”

The consumer 140 receives and consumes the message.

An interface between the publisher 110 and the consumer 140 is minimized due to the presence of the message-oriented middleware, thereby achieving loose coupling.

Further, due to the presence of the exchange 134, the need for the publisher 110 and the consumer 140 to know mutual physical positions (such as IP (Internet Protocol) addresses) on a network is eliminated.

Further, due to the presence of the queue 136, the need for the publisher 110 and the consumer 140 to be in a communicatable state at a same time is eliminated. Asynchrony is thereby improved.

Transmission of a message in accordance with the AMQP is performed as follows. A new message is generated on the publisher 110, using an AMQP client API (Application Program Interface). The publisher 110 stores the body of the message, management information, and so forth in the message. Next, the publisher 110 sets delivery information in the message. Then, the publisher 110 transmits the message to the exchange 134 that operates on the server 130.

When the message arrives at the server 130, the exchange 134 determines the queue 136 of a delivery destination, according to the delivery information added to the message and a rule in the server 130, and then delivers the message. There may be a plurality of the queues of delivery destinations. When there is no delivery destination of the message, the exchange 135 can discard the message or return the message to the publisher 110. When one message is delivered to a plurality of the queues 136, one or more copies of the message should be generated, or the message should be managed using the number of references.

The delivery destination is determined as follows. In a Pub-Sub communication model, for example, a keyword (hereinafter referred to as a “tag”) is added to a transmission message. Upon receipt of the tag, the exchange 134 delivers the message to a queue associated with a consumer (referred to as a “subscriber” in the Pub-Sub communication model) that subscribes in advance. In a Fanout communication model, the exchange 134 delivers the message to a queue associated with each consumer that participates in the message delivery. Though a description will be hereinafter given based on the Pub-Sub communication model, the present invention is not limited to be applied to the Pub-Sub communication model. The present invention can also be applied to a different communication model.

When the message arrives at the queue 136, the queue 136 tries to immediately transmit the message to the consumer 140. When the queue 136 cannot immediately deliver the message, the queue 136 holds the message and waits for completion of preparation at the consumer 140. When the consumer 140 is not present, the queue 136 can also return the message to the publisher 110.

When the queue 136 completes delivery of the message to the consumer 140, the message is deleted from the queue 136. A timing of deleting the message can be controlled, based on an acknowledged message ack replied from the consumer 140, as an example.

The consumer 140 can also reply the acknowledged message ack immediately after delivery of the message. The consumer 140 can also reply the acknowledged message ack after having appropriately processed the message. Further, the consumer 140 can also reply a message nack configured to reject the message.

Patent Literature (PTL) 1 describes a control flow of a message among a publisher client, a subscriber client, and middleware.

Patent Literature 2 describes a computer system based on Openflow (described in Non Patent Literature 2). The computer system described in Patent Literature 2 includes a controller and switches that hold a flow table in which a flow entry is set by the controller and perform a relay operation defined in the flow entry for a received packet matching the flow entry.
PTL 1:
JP Patent Kohyo Publication No. JP-P-2011-505048A
PTL 2:
JP Patent Kokai Publication No. JP-P-2011-146982A
NPL 1:
“AMQP Advanced Message Queuing Protocol, Protocol Specification, Version 0-9-1,” November 13, 2008.
NPL 2:
“OpenFlow Switch Specification, Version 1.1.0 Implemented (Wire Protocol 0x02),” February 28, 2011.

### SUMMARY

Each disclosure of the above-listed Patent Literatures and the above-listed Non Patent Literatures is incorporated herein by reference. The following analysis has been given by the inventor of the present invention.

In the message delivery system (in FIG. 7) based on the AMQP, there is a problem that the number of hops for a message to be transmitted from the publisher 110 and then to be received by the consumer 140 is large (or latency is large).

FIG. 8 is a diagram for explaining this problem. Referring to FIG. 8, the exchange 134 and the queue 136 are present on the server (also referred to as a broker) 130. Thus, a message is once received by the server 130 from publishers 110a to 110c through a switch 120. Further, the exchange 134 stores the message in the queue of a destination. Then, the message passes through the switch 120 again and is then delivered to consumers 140a to 140c. In this case, the message passes through the switch 120 at least twice. Depending on a network configuration, the message may pass through the switch three times or more, as in a case where the switch has multiple stages. Accordingly, in the message delivery system illustrated in FIG. 7, an increase in the number of hops is brought about, so that latency increases.

In message delivery in the message-oriented middleware, information (such as a tag) for an application layer (layer 7 or L7) of an OSI (Open Systems Interconnection) reference model is used for determining a delivery destination of a message, thereby achieving flexible delivery. Accordingly, it is difficult to incorporate a function corresponding to the exchange into a network switch (router) configured to communicate the message based on information for common layer 2 (L2) and layer 3 (L3). Thus, it is impossible to simply omit the server (broker) 130 in FIG. 8.

In the message delivery system illustrated in FIG. 7, the Server (broker) 130 may become a bottleneck.

The reason for that is that all messages are sure to pass through the server 130 because the exchange 134 and the queue 136 are present on the server 130. A load on a process such as copying of a message related to the queue 136 or management of a message stored in the queue 136 is especially large. A load on the server 130 remarkably increases when a message amount is large, when the number of the queues is large (e.g., when the number of the consumers (subscribers) is large), when consumer's processing performance is low with respect to a speed at which the messages enter into the consumer and the queue length thereby increases, or the like.

As mentioned above, in the related arts illustrated in FIGS. 7 and 8, an increase in the number of hops of a message due to relay of the message by the server 130 configured to determine a delivery destination and bottlenecking due to load concentration become a problem in the message delivery in the message-oriented middleware.

Then, it is therefore demanded that the number of hops for the message to be transmitted from the publisher and then to be received by the subscriber be reduced (or the latency be reduced) and that the server is avoided from becoming the bottleneck.

According to a first aspect of the present invention, there is provided a controller for controlling a switch that forwards a message, the controller comprising:
a holding unit that, upon receipt of a notification including a tag from a second node that subscribes to a message delivered with the tag from a first node, associates and holds the tag and a virtual address, and associates and holds the virtual address and a physical address of the second node that transmits the notification;
a setting unit that sets in the switch the association between the virtual address and the physical address; and
a tag resolution unit that, upon receipt of an inquiry about a virtual address associated with the tag from the first node, responds the virtual address.

According to a second aspect of the present invention, there is provided a message delivery system, comprising:
a first node that delivers a message with a tag;
a switch that forwards the message;
a controller that controls forwarding of the message by the switch; and
a second node that subscribes to the message, wherein the second node transmits to the controller a notification including the tag,
upon receipt of the notification, the controller associates and holds the tag and a virtual address, associates and holds the virtual address and a physical address of the second node that transmits the notification, and sets in the switch the association between the virtual address and the physical address,
the first node makes an inquiry to the controller about a virtual address associated with the tag, and transmits the message using as a destination the virtual address obtained by the inquiry, and upon receipt of the message from the first node, the switch rewrites the virtual address included in the destination of the message to the physical address associated with the virtual address, and forwards the message.

According to a third aspect of the present invention, there is provided a message delivery method, comprising:
by a controller that controls a switch for forwarding a message, receiving a notification including a tag from a second node that subscribes to a message, the message being delivered with the tag from a first node;
associating and holding the tag and a virtual address, and associating and holding the virtual address and a physical address of the second node that transmits the notification;
setting in the switch the association between the virtual address and the physical address; and
upon receipt of an inquiry about a virtual address associated with the tag from the first node, responding the virtual address.

According to a fourth aspect of the present invention, there is provided a program causing a computer that controls a switch for forwarding a message to execute:
receiving a notification including a tag from a second node that subscribes to a message, the message being delivered with the tag from a first node;
associating and holding the tag and a virtual address, and associating and holding the virtual address and a physical address of the second node that transmits the notification;
setting in the switch the association between the virtual address and the physical address; and
upon receipt of an inquiry about a virtual address associated with the tag from the first node, responding the virtual address. The program can be provided as a program product recorded on a non-transitory computer-readable storage medium.

The present invention provides the following advantage, but not restricted thereto. According to the controller, the message delivery system, the message delivery method, and the program according to the present invention, the number of hops for a message to be transmitted from a publisher and then to be received by a subscriber can be reduced (or latency can be reduced), and a server can be avoided from becoming a bottleneck.

### BRIEF DESCRIPTION OF THE DRAWINGS

FIG. 1 is a block diagram illustrating a configuration of a message delivery system according to a first exemplary embodiment, as an example.

FIG. 2 includes tables illustrating a configuration of a delivery table as an example.

FIG. 3 is a diagram for explaining an effect of the message delivery system according to the first exemplary embodiment.

FIG. 4 is a diagram illustrating operations of the message delivery system according to the first exemplary embodiment, as an example.

FIG. 5 is a block diagram showing a configuration of a message delivery system according to a second exemplary embodiment, as an example.

FIG. 6 is a diagram illustrating operations of the message delivery system according to the second exemplary embodiment, as an example.

FIG. 7 is a block diagram illustrating a configuration of an AMQP, as an example of a message-oriented middleware.

FIG. 8 is a diagram for explaining a problem of the message-oriented middleware.

### PREFERRED MODES

In the present disclosure, there are various possible modes, which includes the following, but not restricted thereto. First, an overview of one exemplary embodiment will be described. Reference sign in the drawings appended to this overview are an exemplification for helping understanding alone, and are not intended to limit the present invention to the illustrated mode.

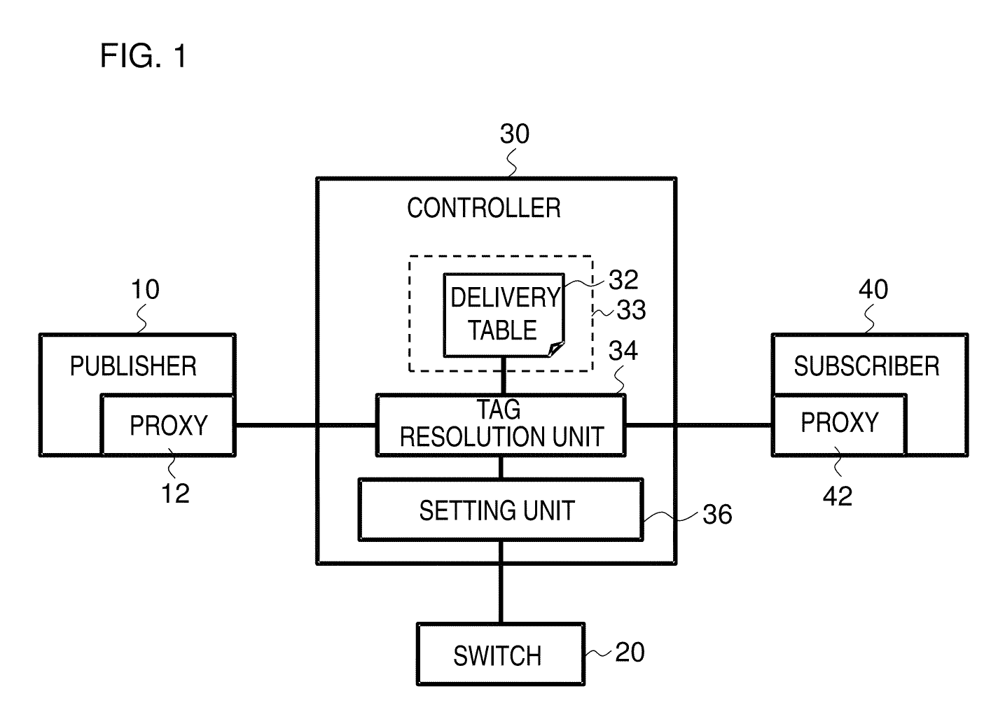

FIG. 1 is a block diagram illustrating a configuration of a message delivery system according to the present invention, as an example. Referring to FIG. 1, the message delivery system comprises a first node (publisher 10) that delivers a message with a tag, a switch (20) that forwards the message, a controller (30) that controls forwarding of the message by the switch, and a second node (subscriber 40) that subscribes to the message.

The controller (30) comprises holding means (unit) (33), setting means (unit) (36), and tag resolution means (unit) (34). Upon receipt of a notification including a tag from the second node (40) that subscribes to a message delivered with the tag from a first node (10), the holding means (unit) (33) associates and holds the tag and a virtual address, and associates and holds (for example, as a delivery table 32) the virtual address and a physical address of the second node (40) that transmits the notification. The setting means (unit) (36) sets in the switch (20) the association between the virtual address and the physical address. Upon receipt of an inquiry about a virtual address associated with the tag from the first node (10), the tag resolution means (unit) (34) responds the virtual address.

The second node (40) transmits to the controller (30) the notification including the tag. Upon receipt of the notification, the controller (30) associates and holds the tag and a virtual address, associates and holds the virtual address and a physical address of the second node (40), and sets in the switch (20) the association between the virtual address and the physical address. The first node (10) makes an inquiry to the controller (30) about a virtual address associated with the tag, and transmits the message using as a destination the virtual address obtained by the inquiry. Upon receipt of the message from the first node (10), the switch (20) rewrites the virtual address included in the destination of the message to the physical address associated with the virtual address, forwards the message. With the above-mentioned arrangement, delivery of the message to the second node (40) is performed.

According to the message delivery system mentioned above, the number of hops for the message to be transmitted from the first node (publisher) and then to be received by the second node (subscriber) can be reduced (or latency can be reduced), and a specific node (such as a server in a related art) can be avoided from becoming a bottleneck.

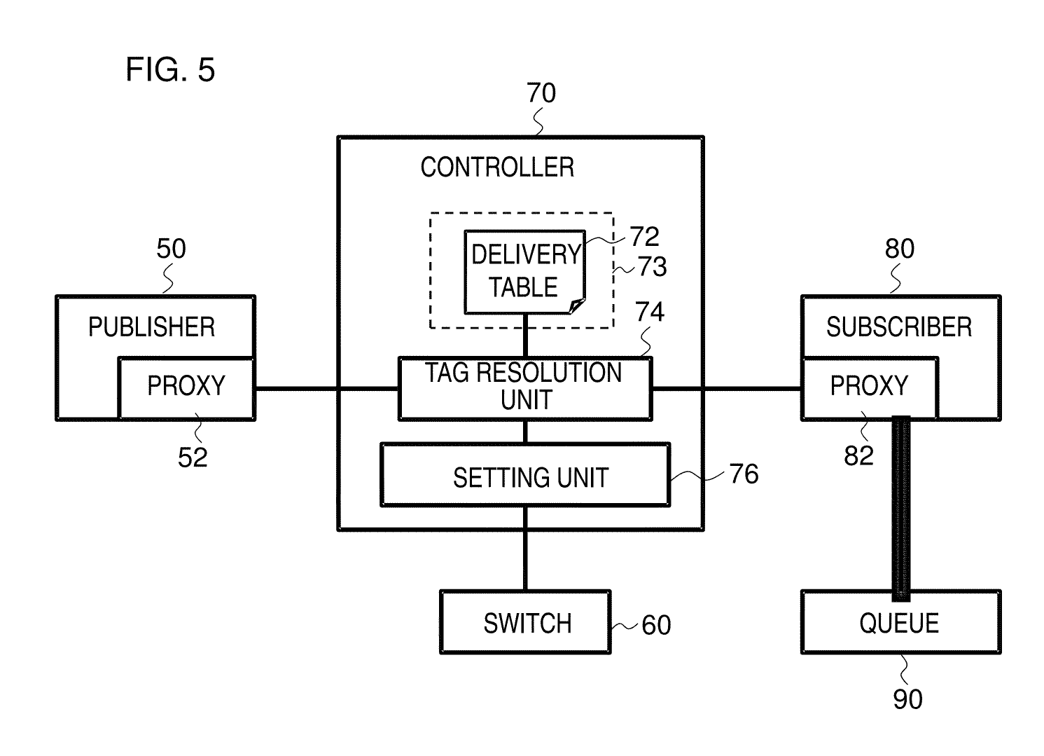

Referring to FIG. 5, a message delivery system may further comprise a third node (queue 90) that temporarily stores a message. In this case, a second node (subscriber 80) transmits to a controller (70) a notification including a tag and a physical address of the third node (90). Upon receipt of the notification, the controller (70) associates and holds the tag and a virtual address, and associates and holds the virtual address and the physical address of the third node (90), and sets in a switch (60) the association between the virtual address and the physical address of the third node (90). Upon receipt of the message from a first node (publisher 50), the switch (60) rewrites the virtual address included in the destination of the message to the physical address of the third node (90), which is associated with the virtual address, and forwards the message. In this case, the second node (80) can receive delivery of the message from the first node (50) through the queue (90).

According to the message delivery system as mentioned above, loose coupling and asynchrony between the first node (50) and the second node (80) can be achieved by providing the third node (queue 90). Further, a plurality of the third nodes (queues 90) can be installed separated from an exchange. Thus, the queue can be avoided from becoming a bottleneck.

According to the present invention, the following modes are possible.

### (First Mode)

A controller may be the controller according to the first aspect described above.

### (Second Mode)

The first node may transmit the message using as a destination the virtual address obtained by the inquiry, and
upon receipt of the message from the first node, the switch may rewrite the virtual address included in the destination of the message to the physical address, which is associated with the virtual address and set in the switch, and forward the message.

### (Third Mode)

Upon receipt from the second node of a notification including the tag and a physical address of a third node that temporarily stores the message, the holding means (unit) may associate and hold the tag and the virtual address, and associate and hold the virtual address and the physical address of the third node, and
the setting means (unit) may set in the switch the association between the virtual address and the physical address of the third node.

### (Fourth Mode)

Upon receipt of the message from the first node, the switch may rewrite the virtual address included in the destination of the message to the physical address of the third node, which is associated with the virtual address, and forward the message.

### (Fifth Mode)

The tag may be information for determining a delivery destination to be set at an application layer of an OSI (Open Systems Interconnection) reference model.

### (Sixth Mode)

The virtual address may be a combination of a virtual IP (Internet Protocol) address and a virtual port number, and
the physical address may be a combination of a physical IP address and a physical port number.

### (Seventh Mode)

A message delivery system may be the message delivery system according to the second aspect described above.

### (Eighth Mode)

The message delivery system may further comprise:
a third node that temporarily stores the message, wherein the second node may transmit to the controller a notification including the tag and a physical address of the third node,
upon receipt of the notification, the controller may associate and hold the tag and the virtual address, and associate and hold the virtual address and the physical address of the third node, and set in the switch the association between the virtual address and the physical address of the third node, and
upon receipt of the message from the first node, the switch may rewrite the virtual address included in the destination of the message to the physical address of the third node, which is associated with the virtual address, and forward the message.

### (Ninth Mode)

A message delivery method may be the message delivery method according to the third aspect described above.

### (Tenth Mode)

The message delivery method may comprise:
by the first node, transmitting the message using as a destination the virtual address obtained by the inquiry; and
by the switch, upon receipt of the message from the first node, rewriting the virtual address included in the destination of the message to the physical address, which is associated with the virtual address and set in the switch, and forwarding the message.

### (Eleventh Mode)

The message delivery method may comprise:
by the controller, receiving from the second node a notification including the tag and a physical address of a third node that temporarily stores the message;
associating and holding the tag and the virtual address, and associating and holding the virtual address and the physical address of the third node; and
setting in the switch the association between the virtual address and the physical address of the third node.

### (Twelfth Mode)

The message delivery method may comprise:
by the switch, upon receipt of the message from the first node, rewriting the virtual address included in the destination of the message to the physical address of the third node, which is associated with the virtual address, and forwarding the message.

### (Thirteenth Mode)

A program may be the program according to the fourth aspect described above.

### (Fourteenth Mode)

The program may cause the computer to execute:
receiving from the second node a notification including the tag and a physical address of a third node that temporarily stores the message;
associating and holding the tag and the virtual address, and associating and holding the virtual address and the physical address of the third node; and
setting in the switch the association between the virtual address and the physical address of the third node.

### (First Exemplary Embodiment)

A message delivery system according to a first exemplary embodiment will be described in detail, with reference to the drawings.

FIG. 1 is a block diagram illustrating a configuration of the message delivery system according to this exemplary embodiment, as an example. The message delivery system can be implemented as message-oriented middleware, as an example.

Referring to FIG. 1, the message delivery system includes a publisher 10 configured to transmit a message, a subscriber 40 configured to receive the message, a switch 20 configured to transfer the message, and a switch controller (hereinafter referred to as a “controller”) 30 configured to control the switch 20. The publisher 10 and the subscriber 40 respectively include proxies 12 and 42. The proxies 12 and 42 convert Pub-Sub communication to a procedure specific to this exemplary embodiment, while following an interface for the Pub-Sub communication.

The controller 30 includes holding means (unit) 33 for holding a delivery table 32 in which association between a tag added to the message and the subscriber of a delivery destination is recorded, tag resolution means (unit) 34 for determining the subscriber of the delivery destination from the tag, using the delivery table 32, and setting means (unit) 36 for performing routing of the switch 20.

As the switch 20, a switch such as an OpenFlow switch configured to communicate a message based on information up to layer 4 (L4) in an OSI reference model and allows routing control of the switch to be changed by an external controller using software can be used.

Referring to FIG. 1, only logical connections are described, and physical connections are omitted. All of the publisher 10, the controller 30, and the subscriber 40 are physically connected to the switch 20, and communication between respective ones of the publisher 10, the controller 30, and the subscriber 40 is possible.

When the publisher 10 transmits a message, a tag for determining a delivery destination is added to the message. Using the proxy 12, the publisher 10 obtains from the controller a combination of a virtual IP address and a virtual port number (hereinafter referred to as a “virtual address”) associated with the message to which the tag has been added.

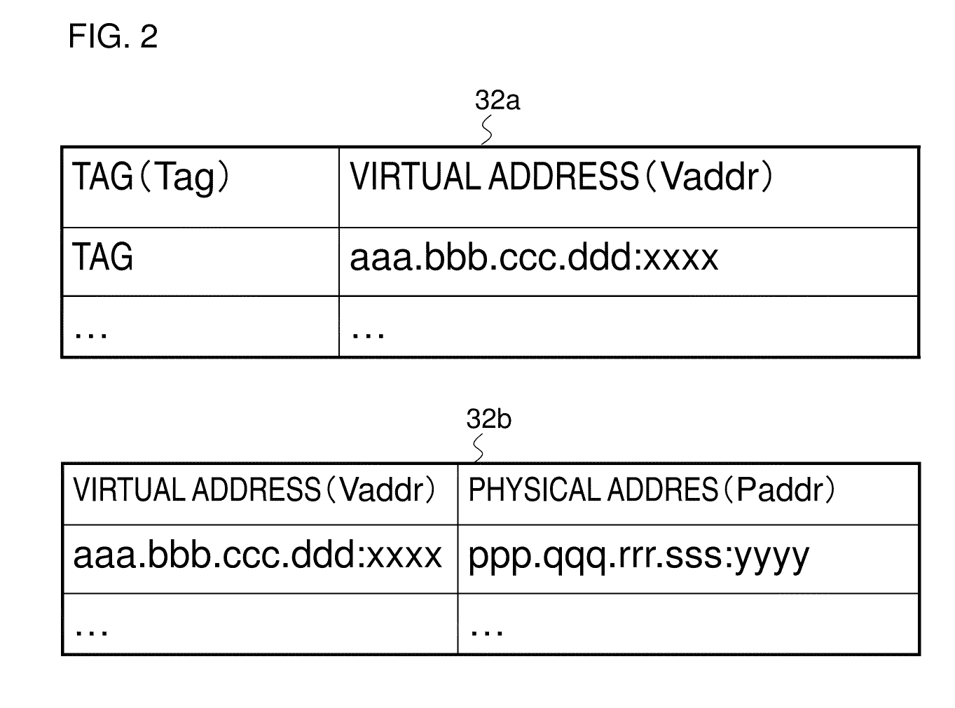

FIG. 2 includes tables illustrating a configuration of the delivery table 32 as an example. Referring to FIG. 2, the delivery table 32 includes two tables 32a and 32b. The table 32a holds a virtual address (Vaddr) associated with a tag. On the other hand, the table 32b holds a combination of a physical IP address associated with the virtual address and a physical port number (hereinafter referred to as a “physical address”)(Paddr).

The proxy 12 transmits the message using the virtual address as the destination.

When routing control of the switch 20 is appropriately performed by the controller 30, the message addressed to the virtual address is transmitted to the physical address associated with the virtual address by the switch 20, and is finally delivered to the subscriber 40 that is to receive the message with the tag added thereto.

When starting receipt (subscription) of the message, the subscriber 40 sends a Subscribe message to the controller 30, using the proxy 42. The controller 30 that has received the Subscribe message generates a unique virtual address when the virtual address associated with the tag specified at the time of the subscription is not present. The controller 30 registers the generated virtual address in the table 32a (in FIG. 2) included in the delivery table 32, as an entry, together with the physical address associated with the virtual address.

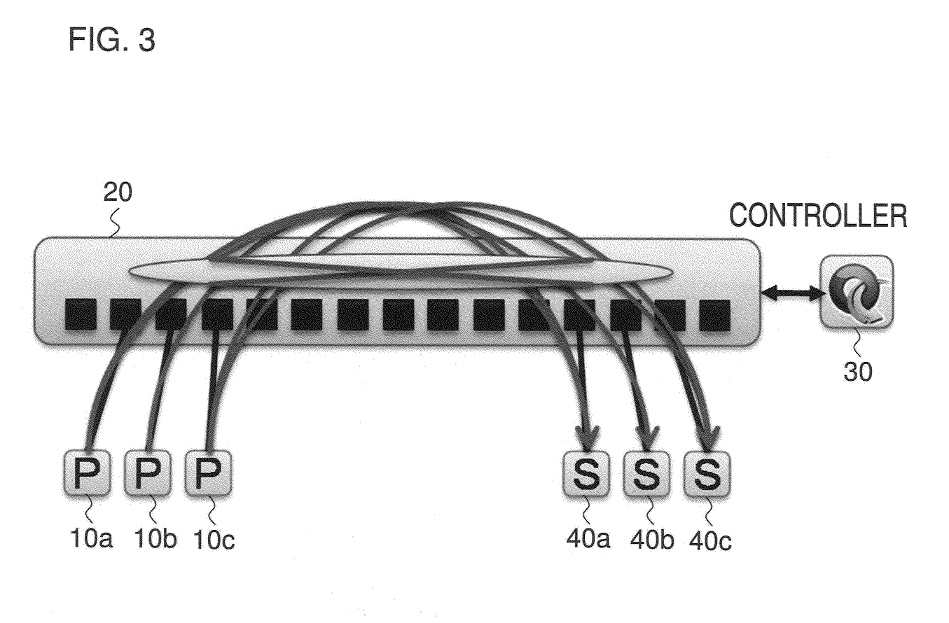

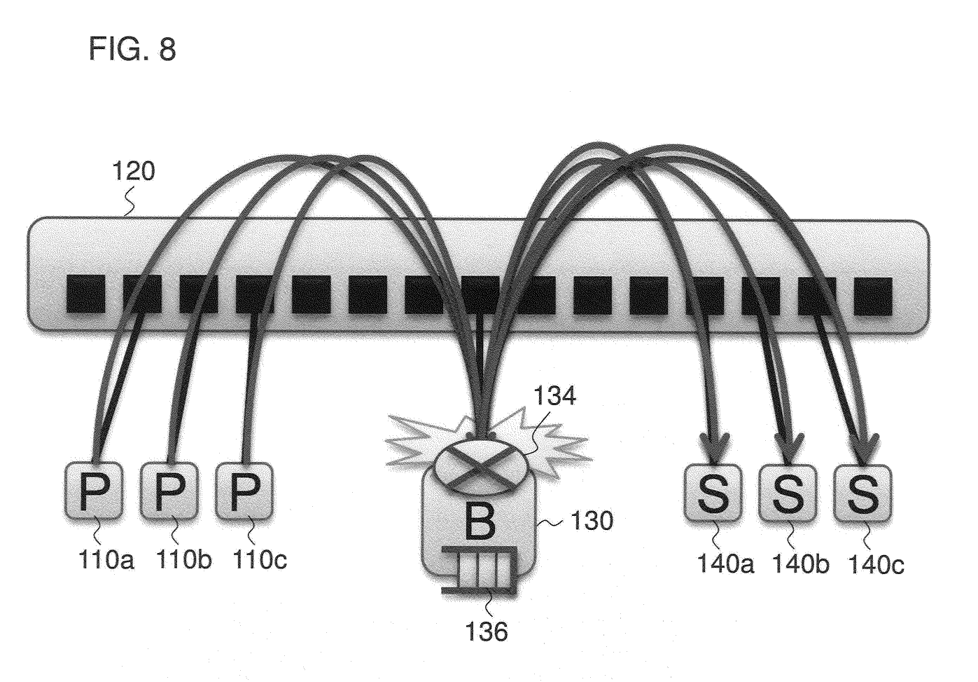

FIG. 3 is a diagram illustrating operations of the message delivery system according to this exemplary embodiment, as an example. According to the configuration in this exemplary embodiment, which is different from the configuration of a related art illustrated in FIG. 8, a function corresponding to an exchange 134 is implemented by the switch 20 and the controller 30, and a queue 136 is removed. A bottleneck can be thereby removed.

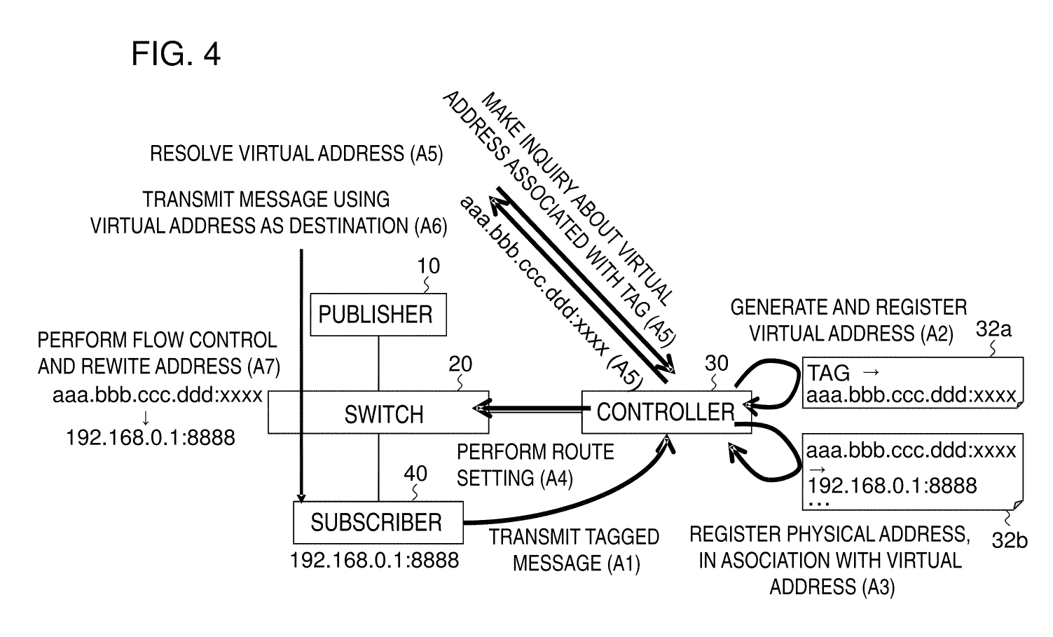

Next, overall operations of the message delivery system according to this exemplary embodiment will be described in detail. FIG. 4 is a diagram illustrating the operations of the message delivery system according to this exemplary embodiment.

Referring to FIG. 4, the subscriber 40 transmits via the proxy 42 to the tag resolution means (unit) 34 on the controller 30 a Subscribe message informing to receive (subscribe to) a tagged message (in step A1). The Subscribe message includes a tag.

The tag resolution means (unit) 34 refers to the delivery table 32 to check whether or not an entry associated with the tag is already present. When the entry associated with the tag is not present, the tag resolution means (unit) 34 generates a unique virtual address associated with the tag, and registers the unique virtual address, in association with the tag (in step A2). On the other hand, when the entry associated with the tag is present, the tag resolution means (unit) 34 uses the association between the tag and a virtual address described in the entry.

Next, the tag resolution means (unit) 34 registers the physical address of the subscriber 40 that has subscribed to with respect to the virtual address (in step A3). When there is a different subscriber that has already subscribed, the tag resolution means (unit) 34 performs entry addition. In OpenFlow, an entry is referred to as an “OpenFlow entry.”

The tag resolution means (unit) 34 performs route setting with respect to the switch (“OpenFlow Switch” in the case of the OpenFlow) 20, based on the entry, using the setting means (unit) 36 (in step A4).

When transmitting the message, the publisher 10 resolves the virtual address associated with the tag added to the message through the proxy 12 (in step A5). When the proxy 12 on the publisher 10 makes an inquiry to the controller 30 about the virtual address associated with the tag, the tag resolution means (unit) 34 refers to the table 32a included in the delivery table 32, and then responses the virtual address associated with the tag (in step A5).

Next, the publisher 10 transmits the message with the virtual address used as a destination (in step A6).

The switch 20 that has received the message rewrites the virtual address to the physical address, based on information on the route that has been set, and then delivers the message to the subscriber (in step A7). When the virtual address is developed into a plurality of physical addresses, the switch 20 delivers the message to a plurality of the subscribers.

When tag resolution cannot be performed in step A5, the controller 30 may reply an error to the publisher 10. When the destination cannot be rewritten in step A7, the switch 20 may reply an error to the publisher 10.

According to this exemplary embodiment, the function of the exchange 134 on a server 130 in the related art (in FIG. 8) can be implemented by the switch 20 and the controller 30, and the queue 136 can be thereby removed. With such a configuration, an increase in the number of hops due to inevitable passage of a message through the server 130 during delivery of the message and an increase in latency due to the increase in the number of the hops can be avoided.

Further, according to this exemplary embodiment, resolution to a physical address is performed by the switch 20, using a virtual address. Message copying can be thereby performed on the side of the switch 20 rather than on the side of the publisher 100. Accordingly, an amount of communication between the publisher 10 and the switch 20 can be reduced.

In the message delivery system in this exemplary embodiment, the controller 30 includes the delivery table 32 configured to manage association from a tag to a virtual address and association from the virtual address to a physical address. Then, the controller 30 performs control so that conversion from the virtual address to the physical address is performed by the switch 20. When a message is transmitted, the publisher 10 obtains the virtual address from the tag and transmits the message to the virtual address. Further, the switch 20 that has received the message rewrites the destination of the message from the virtual address to the physical address, and then delivers the message to the subscriber 40.

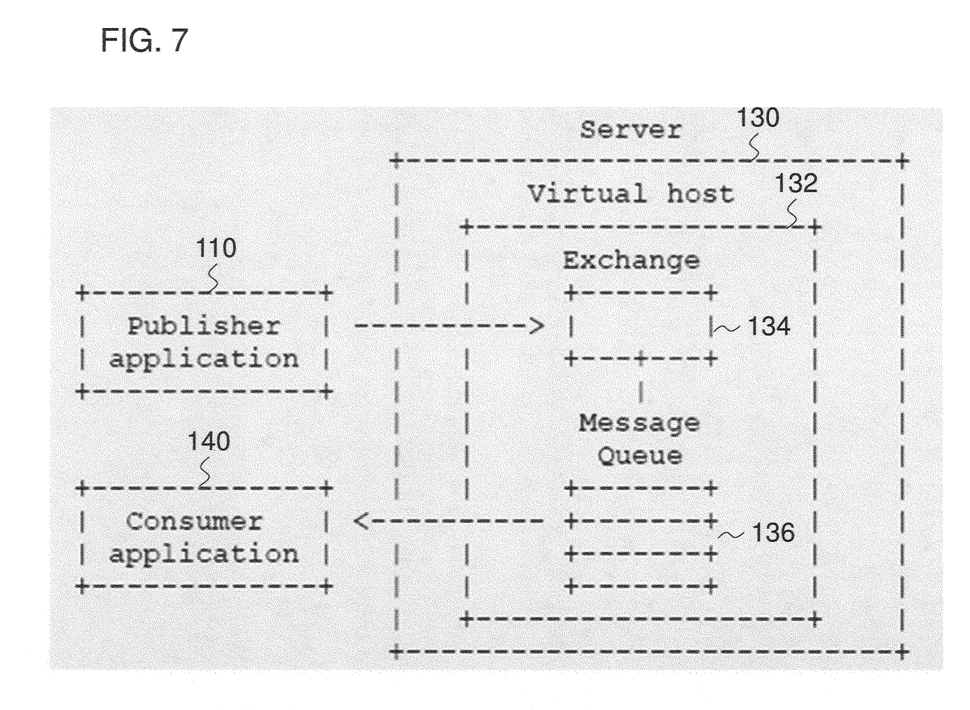

With this arrangement, the exchange 134 in the related art (illustrated in FIGS. 7 and 8) is replaced by the switch 20 and the controller 30. As an example of the switch 20, a switch such as an OpenFlow-compliant switch that can change routing control from an outside can be adopted.

According to such a message delivery system, the number of hops for a message to be transmitted from the publisher 10 and then to be received by the subscriber 40 can be reduced more than that in the related art (illustrated in FIGS. 7 and 8), so that the latency can be reduced.

### (Second Exemplary Embodiment)

Next, a message delivery system according to a second exemplary embodiment will be described, with reference to the drawings.

FIG. 5 is a block diagram illustrating a configuration of the message delivery system according to this exemplary embodiment, as an example. The message delivery system can be implemented as message-oriented middleware, as an example.

Referring to FIG. 5, the message delivery system includes a publisher 50 configured to transmit a message, a subscriber 80 configured to receive the message, a switch 60 configured to transfer the message, and a controller 70 configured to control the switch 60. The publisher 50 and the subscriber 80 respectively include proxies 52 and 82. The proxies 52 and 82 convert Pub-Sub communication to a procedure specific to this exemplary embodiment, while following an interface for the Pub-Sub communication.

The controller 70 includes holding means (unit) 73 for holding a delivery table 72 in which association between a tag added to the message and the subscriber of a delivery destination is recorded, tag resolution means (unit) 74 for determining the subscriber of the delivery destination from the tag, using the delivery table 72, and setting means (unit) 76 for performing route setting of the switch 60.

As the switch 60, a switch such as an OpenFlow switch configured to communicate a message based on information up to layer 4 (L4) of an OSI reference model and allows routing control of the switch to be changed by an external controller using software can be used.

Referring to FIG. 5, the message delivery system in this exemplary embodiment is obtained by adding a queue 90 to the message delivery system according to the first exemplary embodiment (in FIG. 1). The queue 90 may be associated with the subscriber 80 in a one-to-one correspondence, or one queue may be associated with a plurality of the subscribers. Further, a plurality of the queues may be provided for one subscriber.

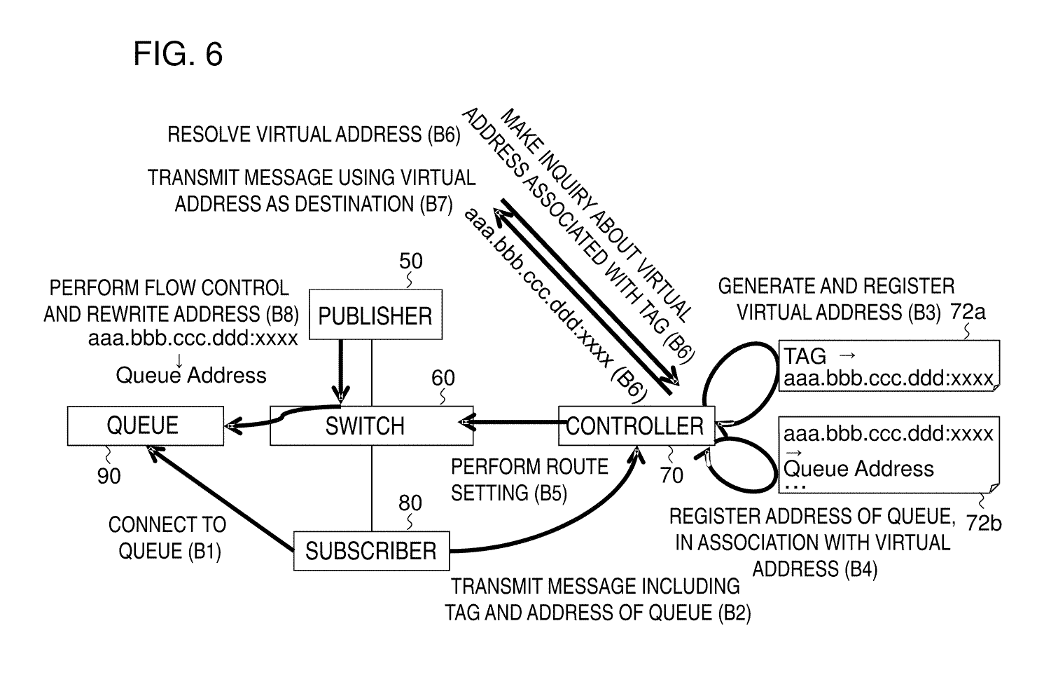

Next, overall operations of the message delivery system according to this exemplary embodiment will be described in detail. FIG. 6 is a diagram illustrating the operations of the message delivery system according to this exemplary embodiment.

Referring to FIG. 6, the subscriber 80 first connects to the queue 90 (in step B1).

Next, the subscriber 80 transmits to the tag resolution means (unit) 74 on the controller 30 a Subscribe message informing to receive (subscribe to) a tagged message through the proxy 82 (in step B2). The Subscribe message includes a tag and an address of the queue 90.

The tag resolution means (unit) 74 refers to the delivery table 72 to check whether or not an entry associated with the tag is already present. When the entry associated with the tag is not present, the tag resolution means (unit) 74 generates a unique virtual address associated with the tag and registers the unique virtual address, in association with the tag (in step B3). On the other hand, when the entry associated with the tag is present, the tag resolution means (unit) 74 uses the association between the tag and the virtual address described in the entry.

Next, the tag resolution means (unit) 74 registers the address of the queue 90, in association with the virtual address (in step B4).

The tag resolution means (unit) 74 performs route setting with respect to the switch 60, using the setting means (unit) 76 (in step B5).

When transmitting the message, the publisher 50 resolves the virtual address associated with the tag added to the message through the proxy 52 (in step B6). When the proxy 52 on the publisher 50 makes an inquiry to the controller 70 about the virtual address associated with the tag, the tag resolution means (unit) 74 refers to a table 72a included in the delivery table 72, and then responses the virtual address associated with the tag (in step B6).

Next, the publisher 50 transmits the message with the virtual address used as a destination (in step B7).

The switch 60 that has received the message rewrites the virtual address to a physical address, based on information on the route that has been set and then delivers the message to the queue 90 (in step B8). When the virtual address is developed into physical addresses of a plurality of the queues, the switch 60 delivers the message to the plurality of the queues.

When tag resolution cannot be performed in step B6, the controller 70 may replay an error to the publisher 50. When the destination cannot be rewritten in step B8, the switch 60 may replay an error to the publisher 50.

The operations of the message delivery system (in FIG. 6) according to this exemplary embodiment are different from the operations of the message delivery system according to the first exemplary embodiment (in FIG. 4) in that the subscriber 80 connects to the queue 90 (in step B1), that the virtual address and the address of the queue are registered in the delivery table 72 (in step B4), that the message transmitted by the publisher 50 is delivered to the queue 90 by the switch 60 (in step B8), and that the subscriber 80 receives delivery of the message from the queue 90.

In this exemplary embodiment, by providing the queue 90, loose coupling and asynchrony between the components, which have been lost in the first exemplary embodiment can be implemented. Further, being different from a method in a related art (illustrated in FIGS. 7 and 8), a plurality of the queues 90 can be installed separated from an exchange. Thus, the queue(s) can be avoided from becoming a bottleneck.

The message delivery system according to any one of the first and second exemplary embodiments can be applied to a system configured to perform message delivery control using information for an application layer (L7) in L2 and L3 networks or L4 network, for example. It is desirable that the message delivery systems according to the first and second exemplary embodiments be used selectively according to a characteristic demanded by an application.

Each disclosure of the related art documents such as the above-listed Patent Literatures is incorporated herein by reference. Modification and adjustment of each exemplary embodiment are possible within the scope of the overall disclosure (including the claims) of the present invention and based on the basic technical concept of the present invention. Various combinations and selections of various disclosed elements (including each element in each claim, each element in each exemplary embodiment, each element in each drawing, and the like) are possible within the scope of the claims of the present invention. That is, the present invention naturally includes various variations and modifications that could be made by those skilled in the art according to the overall disclosure including the claims and the technical concept. With respect to a numerical value range described herein, an arbitrary numerical value and a small range included in the numerical value range should be construed to be specifically described even unless otherwise explicitly described.
10, 50, 10a to 10c publisher
12, 42, 52, 82 proxy
20, 60, 120 switch
30, 70 controller
32, 72 delivery table
32a, 32b, 72a, 72b table
33, 73 holding means (unit)
34, 74 tag resolution means (unit)
36, 76 setting means (unit)
40, 40a to 40c, 80 subscriber
90 queue
110, 110a to 110c publisher (publisher application)
130 server (broker)
132 virtual host
134 exchange
136 queue (message queue)
140, 140a to 140c subscriber (consumer application)

1. A controller for controlling a switch that forwards a message, the controller comprising:
a holding unit that, upon receipt of a notification including a tag from a second node that subscribes to a message delivered with the tag from a first node, associates and holds the tag and a virtual address, and associates and holds the virtual address and a physical address of the second node that transmits the notification;
a setting unit that sets in the switch the association between the virtual address and the physical address; and
a tag resolution unit that, upon receipt of an inquiry about a virtual address associated with the tag from the first node, responds the virtual address.

2. The controller according to claim 1, wherein
the first node transmits the message using as a destination the virtual address obtained by the inquiry, and
upon receipt of the message from the first node, the switch rewrites the virtual address included in the destination of the message to the physical address, which is associated with the virtual address and set in the switch, and forwards the message.

3. The controller according to claim 1, wherein
upon receipt from the second node of a notification including the tag and a physical address of a third node that temporarily stores the message, the holding unit associates and holds the tag and the virtual address, and associates and holds the virtual address and the physical address of the third node, and
the setting unit sets in the switch the association between the virtual address and the physical address of the third node.

4. The controller according to claim 3, wherein
upon receipt of the message from the first node, the switch rewrites the virtual address included in the destination of the message to the physical address of the third node, which is associated with the virtual address, and forwards the message.

5. The controller according to claim 1, wherein
the tag is information for determining a delivery destination to be set at an application layer of an OSI (Open Systems Interconnection) reference model.

6. The controller according to claim 1, wherein
the virtual address is a combination of a virtual IP (Internet Protocol) address and a virtual port number, and
the physical address is a combination of a physical IP address and a physical port number.

7. A message delivery system, comprising:
a first node that delivers a message with a tag;
a switch that forwards the message;
the controller according to claim 1; and
a second node that subscribes to the message, wherein
the second node transmits to the controller a notification including the tag,
the first node makes an inquiry to the controller about a virtual address associated with the tag, and transmits the message using as a destination the virtual address obtained by the inquiry, and
upon receipt of the message from the first node, the switch rewrites the virtual address included in the destination of the message to the physical address associated with the virtual address, and forwards the message.

8. The message delivery system according to claim 7, further comprising:
a third node that temporarily stores the message, wherein
the second node transmits to the controller a notification including the tag and a physical address of the third node,
upon receipt of the notification, the controller associates and holds the tag and the virtual address, associates and holds the virtual address and the physical address of the third node, and sets in the switch the association between the virtual address and the physical address of the third node, and
upon receipt of the message from the first node, the switch rewrites the virtual address included in the destination of the message to the physical address of the third node, which is associated with the virtual address, and forwards the message.

9. A message delivery method, comprising:
by a controller that controls a switch for forwarding a message, receiving a notification including a tag from a second node that subscribes to a message, the message being delivered with the tag from a first node;
associating and holding the tag and a virtual address, and associating and holding the virtual address and a physical address of the second node that transmits the notification;
setting in the switch the association between the virtual address and the physical address; and
upon receipt of an inquiry about a virtual address associated with the tag from the first node, responding the virtual address.

10. The message delivery method according to claim 9, comprising:
by the first node, transmitting the message using as a destination the virtual address obtained by the inquiry; and
by the switch, upon receipt of the message from the first node, rewriting the virtual address included in the destination of the message to the physical address, which is associated with the virtual address and set in the switch, and forwarding the message.

11. The message delivery method according to claim 9, comprising:
by the controller, receiving from the second node a notification including the tag and a physical address of a third node that temporarily stores the message;
associating and holding the tag and the virtual address, and associating and holding the virtual address and the physical address of the third node; and
setting in the switch the association between the virtual address and the physical address of the third node.

12. The message delivery method according to claim 11, comprising:
by the switch, upon receipt of the message from the first node, rewriting the virtual address included in the destination of the message to the physical address of the third node, which is associated with the virtual address, and forwarding the message.

13. A non-transitory computer-readable recording medium storing a program that cause a computer, which controls a switch for forwarding a message, to execute:
receiving a notification including a tag from a second node that subscribes to a message, the message being delivered with the tag from a first node;
associating and holding the tag and a virtual address, and associating and holding the virtual address and a physical address of the second node that transmits the notification;
setting in the switch the association between the virtual address and the physical address; and
upon receipt of an inquiry about a virtual address associated with the tag from the first node, responding the virtual address.

14. The non-transitory computer-readable recording medium according to claim 13, wherein
the first node transmits the message using as a destination the virtual address obtained by the inquiry, and
upon receipt of the message from the first node, the switch rewrites the virtual address included in the destination of the message to the physical address, which is associated with the virtual address and set in the switch, and forwards the message.

15. The non-transitory computer-readable recording medium according to claim 13, wherein
the program causes the computer to execute:
receiving from the second node a notification including the tag and a physical address of a third node that temporarily stores the message;
associating and holding the tag and the virtual address, and associating and holding the virtual address and the physical address of the third node; and
setting in the switch the association between the virtual address and the physical address of the third node.

16. The non-transitory computer-readable recording medium according to claim 15, wherein
upon receipt of the message from the first node, the switch rewrites the virtual address included in the destination of the message to the physical address of the third node, which is associated with the virtual address, and forwards the message.

17. The message delivery method according to claim 9, wherein
the tag is information for determining a delivery destination to be set at an application layer of an OSI (Open Systems Interconnection) reference model.

18. The message delivery method according to claim 9, wherein
the virtual address is a combination of a virtual IP (Internet Protocol) address and a virtual port number, and
the physical address is a combination of a physical IP address and a physical port number.

19. The non-transitory computer-readable recording medium according to claim 13, wherein
the tag is information for determining a delivery destination to be set at an application layer of an OSI (Open Systems Interconnection) reference model.

20. The non-transitory computer-readable recording medium according to claim 13, wherein
the virtual address is a combination of a virtual IP (Internet Protocol) address and a virtual port number, and
the physical address is a combination of a physical IP address and a physical port number.
